(19) United States
(12) Patent Application Publication
(10) Pub. No.: US 2024/0304001 A1
(43) Pub. Date: Sep. 12, 2024

(54) SYSTEMS AND METHODS FOR GENERATING A HEATMAP CORRESPONDING TO AN ENVIRONMENT OF A VEHICLE

(71) Applicant: Kodiak Robotics, Inc., Mountain View, CA (US)

(72) Inventors: Kenar Vyas, Palo Alto, CA (US); Sean Roelofs, Soquel, CA (US); Collin C. Otis, Driggs, ID (US); Philip C. Du Toit, Fort Collins, CO (US)

(73) Assignee: Kodiak Robotics, Inc., Mountain View, CA (US)

(21) Appl. No.: 18/179,075

(22) Filed: Mar. 6, 2023

(51) Int. Cl. G06V 20/56; G01S 17/86; G01S 17/894; G01S 17/931; G06V 10/82

(52) U.S. Cl. CPC G06V 20/588; G01S 17/86; G01S 17/894; G01S 17/931; G06V 10/82

(57) ABSTRACT

Systems and methods for detecting a portion of an environment of a vehicle are provided. The method may comprise generating, using one or more sensors coupled to a vehicle, environment data from an environment of the vehicle, wherein the environmental data comprises one or more of the following: ground LiDAR data from the environment; camera data from the environment; and path data corresponding to a change in position of one or more other vehicles within the environment. The method may comprise inputting the environmental data into a machine learning model trained to generate a heatmap, and, using a processor, based on the environmental data, determining a portion of the environment, wherein the portion of the environment comprises an area having a likelihood, greater than a minimum threshold, of being adjacent to one or more pavement markings, and generating the heatmap, wherein the heatmap corresponds to the portion of the environment.

### BACKGROUND

### Field of the Disclosure

Embodiments of the present disclosure relate to image processing for autonomous vehicles and, in particular, to generating heatmaps corresponding to an environment of a vehicle.

### Description of the Related Art

Autonomous vehicles function by collecting data (e.g., imagery, RADAR data, LiDAR data, etc.) from one or more sensors (e.g., cameras, RADAR systems, LiDAR systems, etc.) and processing this data in order to determine aspects of the environment surrounding the autonomous vehicles. These aspects of the environment may comprise the presence or absence of objects within the environment.

By detecting these objects, the autonomous vehicles may better navigate their environments by being better equipped at avoiding these objects and planning trajectories accordingly.

### SUMMARY

According to an aspect of the present disclosure, a method for detecting a portion of an environment of a vehicle is provided. The method may comprise generating, using one or more sensors coupled to a vehicle, environment data from an environment of the vehicle, wherein the environmental data comprises one or more of the following: ground LiDAR data from the environment; camera data from the environment; and path data corresponding to a change in position of one or more other vehicles within the environment. The method may comprise inputting the environmental data into a machine learning model trained to generate a heatmap, and, using a processor, based on the environmental data, determining a portion of the environment, wherein the portion of the environment comprises an area having a likelihood, greater than a minimum threshold, of being adjacent to one or more pavement markings, and generating the heatmap, wherein the heatmap corresponds to the portion of the environment.

According to various embodiments, the one or more sensors may comprise one or more of one or more LiDAR systems, one or more cameras, and one or more RADAR systems.

According to various embodiments, the ground LiDAR data may comprise a 2-dimensional grouping of data points within the environment.

According to various embodiments, the generating ground LiDAR data may comprise capturing, using one or more LiDAR systems, 3-dimensional LiDAR data from the environment, and distilling the 3-dimensional LiDAR data to the ground lidar data.

According to various embodiments, the one or more sensors may comprise one or more cameras configured to generate one or more birds-eye-view images, and the camera data may comprise one or more birds-eye-view images.

According to various embodiments, the processor may be configured to run the machine learning model, and the machine learning model may comprise a convolutional neural network.

According to various embodiments, the generating path data corresponding to a change in position of the one or more other vehicle in the environment may comprise, using the processor, identifying, using image recognition, a first position of one of the one or more other vehicles at a first time, identifying, using image recognition, a second position of the one of the one or more other vehicles at a second time, wherein the second time is after the first time, determining a change in position between the first position and the second position, and generating a visual representation of the change in position.

According to an aspect of the present disclosure, a system for generating a heatmap is provided. The system may comprise a vehicle and an imaging module, coupled to the vehicle. The imaging module may comprise one or more cameras, configured to capture an image depicting an environment within view of the one or more cameras, and a processor. The processor may be configured to generate, using one or more sensors coupled to a vehicle, environment data from an environment of the vehicle, wherein the environmental data comprises one or more of ground LiDAR data from the environment, camera data from the environment, and path data corresponding to a change in position of one or more other vehicles within the environment. The processor may be further configured to input the environmental data into a machine learning model trained to generate a heatmap, based on the environmental data, determine a portion of the environment, wherein the portion of the environment comprises an area having a likelihood, greater than a minimum threshold, of being adjacent to one or more pavement markings, and generate the heatmap, wherein the heatmap corresponds to the portion of the environment.

According to various embodiments, the one or more sensors may comprise one or more of one or more LiDAR systems, one or more cameras, and one or more RADAR systems.

According to various embodiments, the ground LiDAR data may comprise a 2-dimensional grouping of data points within the environment.

According to various embodiments, the generating ground LiDAR data may comprise capturing, using one or more LiDAR systems, 3-dimensional LiDAR data from the environment, and distilling the 3-dimensional LiDAR data to the ground lidar data.

According to various embodiments, the one or more sensors may comprise one or more cameras configured to generate one or more birds-eye-view images, and the camera data may comprise one or more birds-eye-view images.

According to various embodiments, the processor may be configured to run the machine learning model, and the machine learning model may comprise a convolutional neural network.

According to various embodiments, the generating path data corresponding to a change in position of the one or more other vehicle in the environment may comprise, using the processor, identifying, using image recognition, a first position of one of the one or more other vehicles at a first time, identifying, using image recognition, a second position of the one of the one or more other vehicles at a second time, wherein the second time is after the first time, determining a change in position between the first position and the second position, and generating a visual representation of the change in position.

According to an aspect of the present disclosure, a system is provided. The system may comprise an imaging device comprising one or more cameras, the imaging device coupled to a vehicle, wherein the one or more cameras are configured to capture an image depicting an environment within view of the one or more cameras, and a computing device, including a processor and a memory, coupled to the vehicle, configured to store programming instructions. The programming instructions, when executed by the processor, may be configured to cause the processor to generate, using one or more sensors coupled to a vehicle, environment data from an environment of the vehicle, wherein the environmental data comprises one or more of ground LiDAR data from the environment, camera data from the environment, and path data corresponding to a change in position of one or more other vehicles within the environment. The programming instructions, when executed by the processor, may be configured to further cause the processor to input the environmental data into a machine learning model trained to generate a heatmap, based on the environmental data, determine a portion of the environment, wherein the portion of the environment comprises an area having a likelihood, greater than a minimum threshold, of being adjacent to one or more pavement markings, and generate the heatmap, wherein the heatmap corresponds to the portion of the environment.

According to various embodiments, the one or more sensors may comprise one or more of one or more LiDAR systems, one or more cameras, and one or more RADAR systems.

According to various embodiments, the ground LiDAR data may comprise a 2-dimensional grouping of data points within the environment.

According to various embodiments, in the generating ground LiDAR data, the programming instructions, when executed by the processor, may be further configured to cause the processor to capture, using one or more LiDAR systems, 3-dimensional LiDAR data from the environment, and distill the 3-dimensional LiDAR data to the ground lidar data.

According to various embodiments, the processor may be configured to run the machine learning model, and the machine learning model may comprise a convolutional neural network.

According to various embodiments, in the generating path data corresponding to a change in position of the one or more other vehicle in the environment, the programming instructions, when executed by the processor, may be further configured to cause the processor to identify, using image recognition, a first position of one of the one or more other vehicles at a first time, identify, using image recognition, a second position of the one of the one or more other vehicles at a second time, wherein the second time is after the first time, determine a change in position between the first position and the second position, and generate a visual representation of the change in position.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principles of the disclosure. In the drawings:

FIG. 1 illustrates an example autonomous vehicle on a roadway, according to various embodiments of the present disclosure;

FIG. 2 illustrates the example autonomous vehicle of FIG. 1 accompanied by another vehicle on a one-way road;

FIG. 3 is an example flowchart of a method for generating a heatmap, according to various embodiments of the present disclosure;

FIG. 4 is an example block diagram of software for generating a heatmap, according to various embodiments of the present disclosure;

FIG. 5 illustrates example elements of a computing device, according to various embodiments of the present disclosure; and

FIG. 6 illustrates an example architecture of a vehicle, according to various embodiments of the present disclosure.

### DETAILED DESCRIPTION

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and may be implemented by hardware components or software components and combinations thereof.

In this document, when terms such as “first” and “second” are used to modify a noun, such use is simply intended to distinguish one item from another, and is not intended to require a sequential order unless specifically stated. In addition, terms of relative position such as “vertical” and “horizontal”, or “front” and “rear”, when used, are intended to be relative to each other and need not be absolute, and only refer to one possible position of the device associated with those terms depending on the device's orientation.

An “electronic device” or a “computing device” refers to a device that includes a processor and memory. Each device may have its own processor and/or memory, or the processor and/or memory may be shared with other devices as in a virtual machine or container arrangement. The memory contains or receives programming instructions that, when executed by the processor, cause the electronic device to perform one or more operations according to the programming instructions.

The terms “memory,” “memory device,” “computer-readable storage medium,” “data store,” “data storage facility” and the like each refer to a non-transitory device on which computer-readable data, programming instructions or both are stored. Except where specifically stated otherwise, the terms “memory,” “memory device,” “computer-readable storage medium,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process.

The term “module” refers to a set of computer-readable programming instructions, as executed by a processor, that cause the processor to perform a specified function.

The term “vehicle,” or other similar terms, refers to any motor vehicles, powered by any suitable power source, capable of transporting one or more passengers and/or cargo. The term “vehicle” includes, but is not limited to, autonomous vehicles (i.e., vehicles not requiring a human operator and/or requiring limited operation by a human operator), automobiles (e.g., cars, trucks, sports utility vehicles, vans, buses, commercial vehicles, etc.), boats, drones, trains, and the like.

Although exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable programming instructions executed by a processor, controller, or the like. Examples of computer readable media include, but are not limited to, ROM, RAM, compact disc (CD)-ROMs, magnetic tapes, floppy disks, flash drives, smart cards and optical data storage devices. The computer readable medium may also be distributed in network-coupled computer systems so that the computer readable media may be stored and executed in a distributed fashion such as, e.g., by a telematics server or a Controller Area Network (CAN).

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

Hereinafter, some embodiments of the present disclosure will be described in detail with reference to the drawings. In the drawings, the same reference numerals will be used throughout to designate the same or equivalent elements. In addition, a detailed description of well-known features or functions will be ruled out in order not to unnecessarily obscure the gist of the present disclosure.

Hereinafter, systems and methods for downsampling an image to multiple image resolutions, according to embodiments of the present disclosure, will be described with reference to the accompanying drawings.

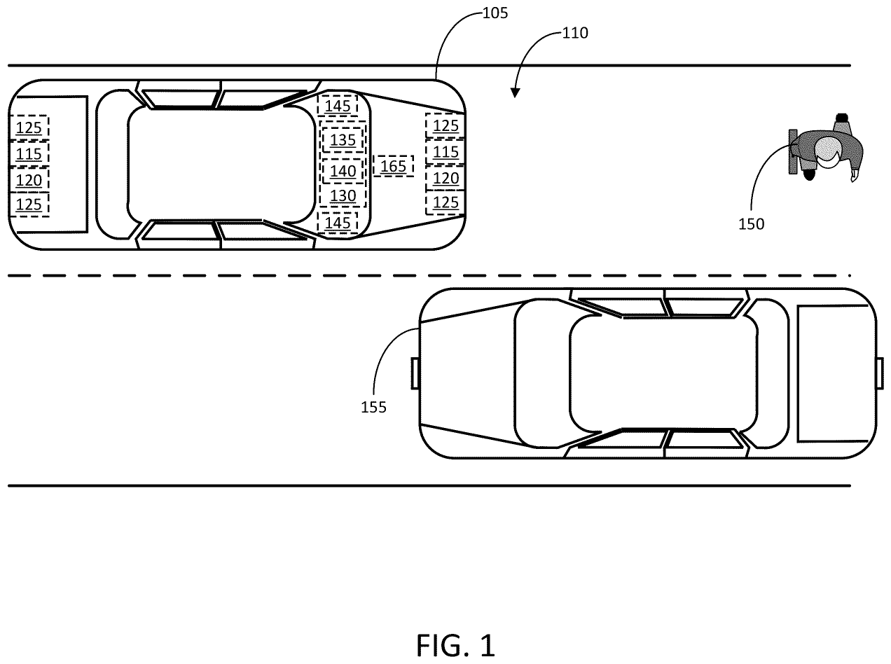

Referring now to FIG. 1, an autonomous vehicle 105 on a roadway 110, is illustratively depicted, in accordance with various embodiments of the present disclosure.

According to various embodiments, the vehicle 105 may comprise one or more detection mechanisms/sensors such as, for example, one or more LiDAR sensors 115, one or more radio detection and ranging (RADAR) sensors 120, and one or more image capturing devices e.g., imaging module 125, which may comprise one or more cameras, among other suitable detection mechanisms/sensors. According to various embodiments, the one or more detection mechanisms/sensors may be in electronic communication with one or more computing devices 130. The computing devices 130 may be separate from the one or more detection mechanisms/sensors and/or may be incorporated into the one or more detection mechanisms/sensors. The vehicle 105 may comprise one or more transceivers 165 configured to send and/or receive one or more signals, messages, alerts, etc. According to various embodiments, the one or more transceivers 165 may be coupled to the one or more computing devices 130 and/or may be separate from the one or more computing devices 130.

In the example of FIG. 1, the imaging module 125 is positioned along the vehicle 105 such that the one or more cameras of the imaging module 125 are configured to image all or part of an environment surrounding the vehicle 105. According to various embodiments, the imaging module 125 may be configured to detect one or more objects (e.g., one or more pedestrians 150, vehicles 155, etc.).

In the example of FIG. 1, the vehicle 105 may comprise one or more location detection systems 145 configured to determine a geographic location and/or region at which the vehicle 105 is located. The location detection system 145 may be, e.g., a Global Positioning System (GPS) device and/or other suitable device and/or system for determining geographic location and/or region. According to various embodiments, the one or more location detection systems 145 may be coupled to the one or more computing devices 130 and/or may be separate from the one or more computing devices 130.

According to various embodiments, the computing device 130 may comprise a processor 135 and/or a memory 140. The memory 140 may be configured to store programming instructions that, when executed by the processor 135, may cause the processor 135 to perform one or more tasks such as, e.g., capturing, using a camera, an image depicting an environment within view of the camera, identifying a first section of the image, wherein the first section depicts an area of the environment spaced within a first distance range from the camera, identifying a second section of the image, wherein the second section depicts an area of the environment spaced within a second distance range from the camera, identifying a third section of the image, wherein the third section depicts an area of the environment spaced within a third distance range from the camera, downsampling the first section of the image to a first image resolution, generating a first processed image, downsampling the second section of the image to a second image resolution, generating a second processed image, downsampling the third section of the image to a third image resolution, generating a third processed image, generating a distance map of the environment of the image, prior to downsampling the first section of the image, the second section of the image, and the third section of the image, downsampling the image to an image resolution lower than an original image resolution, and/or other suitable functions.

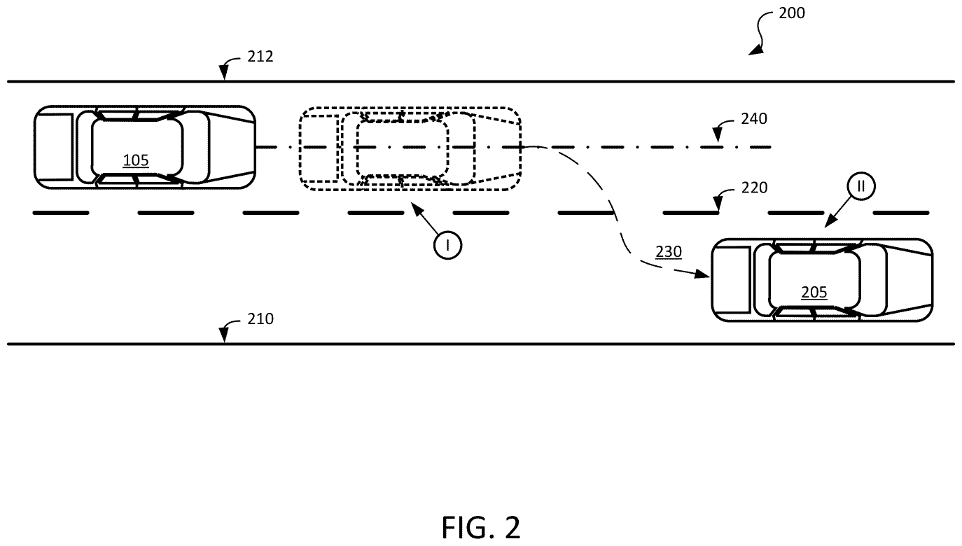

Referring now to FIG. 2, the vehicle 105 is accompanied by a vehicle 205 on a one-way road 200 that comprises a right edge 210, a left edge 212, and a lane divider 220, which is a series of lines painted on the road 200 between the right edge 210 and the left edge 212. In the example of FIG. 2, the vehicle 205 moves from a first position, marked by an inscribed I, to a second position marked by an inscribed II. The vehicle 205 moves from the first position I to the second position II along a path 230.

The vehicle 105 may be configured to use the imaging module 125 and/or the one or more LiDAR sensors 115 to follow the movement of the vehicle 205 along the path 230 and generate path data that approximates the path. For example, the imaging module 125 may be configured to approximate the road 200 as a 2-dimensional space and the path 230 as a curve along the 2-dimensional space. The imaging module 125 may be configured to generate the approximation of the path 230 using a series of images of the vehicle 205 captured by the one or more cameras of the imaging module. As another example, the imaging module 125 may be configured to generate the approximation of the path 230 by tracking the movement of the vehicle 205 using the one or more LiDAR sensors 115.

In general, the vehicle 105 may be configured to collect images using a camera of the imaging module 125. The camera images may depict different views of the environment. For example, the imaging module 125 may comprise a camera having a telephoto lens with a viewing angle ranging from about 1 to about 25 degrees e.g., to capture images of objects that are relatively far from the vehicle 105. As another example, the imaging module 125 may comprise a camera having a standard lens with a viewing angle ranging from about 25 degrees to about 60 degrees. As yet another example, the imaging module 125 may comprise a camera having a wide-angle lens with a viewing angle of about 60 degrees to about 180 degrees. In some implementations, the camera may comprise a lens capable of generating panoramic or birds-eye-view images, e.g., by digitally combining images from one or more of the aforementioned cameras. As used herein, the term birds-eye-view refers to a view of a scene, e.g., the ground, as it would look from an elevated vantage point, such as the vantage point of a bird in flight or a person standing in a window above the ground floor of a building.

The vehicle 105 may be configured to capture information related to the environment of the vehicle using the one or more LiDAR sensors 115. For example, the LiDAR sensors 115 may be configured to capture data that corresponds to a cloud of data points, where each data point occupies a point in a 3-dimensional space surrounding the vehicle 105. As another example, the LiDAR system may be configured to generate data that corresponds to a 2-dimensional space e.g., a portion of road that extends in front of the vehicle 105. Because the data generated by the LiDAR system corresponds to a 2-dimensional space, such as the ground in front of the vehicle 105, the LiDAR data may also be referred to as ground LiDAR data.

The vehicle 105, e.g., using the processor 135, may be configured to use the path data, camera images, and LiDAR data to generate a centerline 240 between the left edge 212 and the lane divider 220. The centerline 240 is computer-generated data that approximates the midpoint of the lane in which the vehicle 105 is located. The centerline 240 may be used in autonomous vehicle navigation, e.g., to facilitate the navigation of an autonomous vehicle along a road. Not only may the vehicle 105 be configured to generate a centerline 240, the vehicle may be configured to use the path data, camera images, and LiDAR data to generate a heatmap of the environment surrounding the vehicle.

In some implementations, the processor 135 may be used to generate the path data, which may comprise identifying, using image recognition, a first position of one of the one or more other vehicles at a first time and identifying, using image recognition, a second position of the one of the one or more other vehicles at a second time. The second time is after the first time such that the path data represents the movement of the other vehicle between two positions. Generating the path data may further comprise determining a change in position between the first position and the second position and generating a visual representation of the change in position.

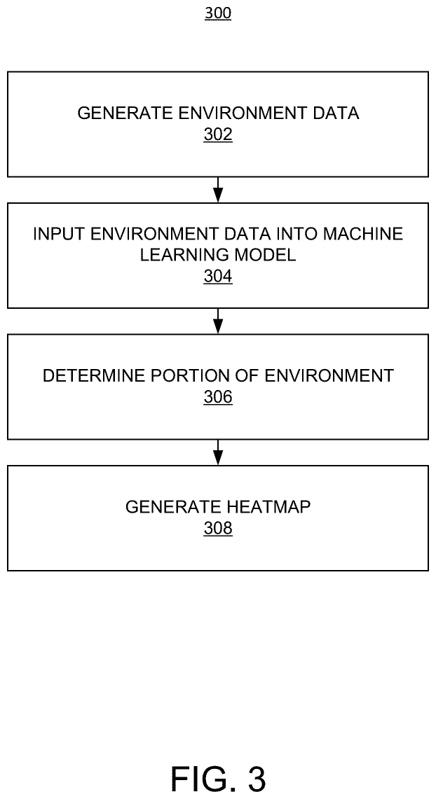

Referring now to FIG. 3 a flowchart of an example method 300 for generating a heatmap is provided. The method 300 is described as being performed by an example system; for example, the imaging module 125 may be configured to perform the method. It is noted, however, that other suitable systems may be used for performing one or more steps of method 300, while maintaining the spirit and functionality of the present disclosure.

At 302, using one or more sensors coupled to a vehicle, environment data, pertaining to an environment of the vehicle, is collected and generated. The environmental data may be sensed, collected, and/or generated via one or more sensors, and/or through one or more other suitable means.

The environment data may comprise ground LiDAR data from the environment, camera data from the environment, path data corresponding to a change in position of one or more other vehicles within the environment, and/or other suitable data. For example, the vehicle may be configured to periodically sample the environment e.g., by capturing images, generating RADAR data, generating LiDAR data, and/or via one or more other suitable means, while maintaining the spirit and functionality of the present disclosure. The vehicle may be configured to detect other vehicles and/or generate path data for each detected vehicle.

The vehicle may be configured to generate the environment data using the one or more sensors which may comprise one or more LiDAR systems, one or more cameras, or one or more RADAR systems, and/or other suitable sensors. In some implementations, the one or more sensors may comprise one or more cameras configured to generate one or more birds-eye-view images. In some implementations, the LiDAR data may comprise a 2-dimensional grouping of data points within the environment. For example, the 2-dimensional grouping may be arranged along the surface of a street in front of the vehicle.

Generating ground LiDAR data may comprise capturing, using one or more LiDAR systems, 3-dimensional LiDAR data from the environment and distilling the 3-dimensional LiDAR data to ground LiDAR data. For example, distilling the 3-dimensional LiDAR data may comprise first identifying which 3-dimensional LiDAR points belong to a ground surface, using a segmentation neural network, and then generating a 2-dimensional birds-eye-view of these points.

At 304, the environmental data is input into a machine learning model trained to generate a heatmap. For example, the machine learning model may comprise one or more convolutional neural networks. According to various embodiments, a convolutional network may be trained using label maps. A “label map” may be a precomputed representation of where the center of lane lines are in a given view. A label may be generated by using a map of where lane lines are that is known beforehand, for example. In such implementations, a label map may then be used to define the desired output when training a convolutional neural network.

In some implementations, the processor may be configured to run the machine learning model. In some implementations, the machine learning model may be configured to run on a remote computing device that may be configured to generate a heatmap and send the generated heatmap to the vehicle over a network. The machine learning model may be trained with data such as LiDAR data, images or videos captured by autonomous vehicles, such as images or videos that show the movement of vehicles, and/or other suitable data.

At 306, based on the environmental data, a portion of the environment which comprises an area having a likelihood, greater than a minimum threshold, of being adjacent to one or more pavement markings is determined. For example, the one or more pavement markings may comprise a lane divider or a left or right edge of a road in the environment of the vehicle.

At 308, the heatmap is generated. The heatmap may correspond to the portion of the environment. The system may be configured to generate the heatmap based on the environmental data. In some implementations, the system may be configured to use the heatmap to suggest one or more changes to the vehicle. For example, the changes may comprise a change in direction or speed of the vehicle. Accordingly, the vehicle may be configured to implement the suggestion if it is operating in an autonomous mode. In other implementations the system may be configured to use the heatmap to generate a representation of the world to be saved for future use. According to various embodiments, a heatmap may be generated through the use of a vertical attention component of a convolutional neural network. The vertical attention component may be configured to enable the network to determine and utilize at least the portion or portions of an image that are deemed important when deciding how to generate a desired heatmap.

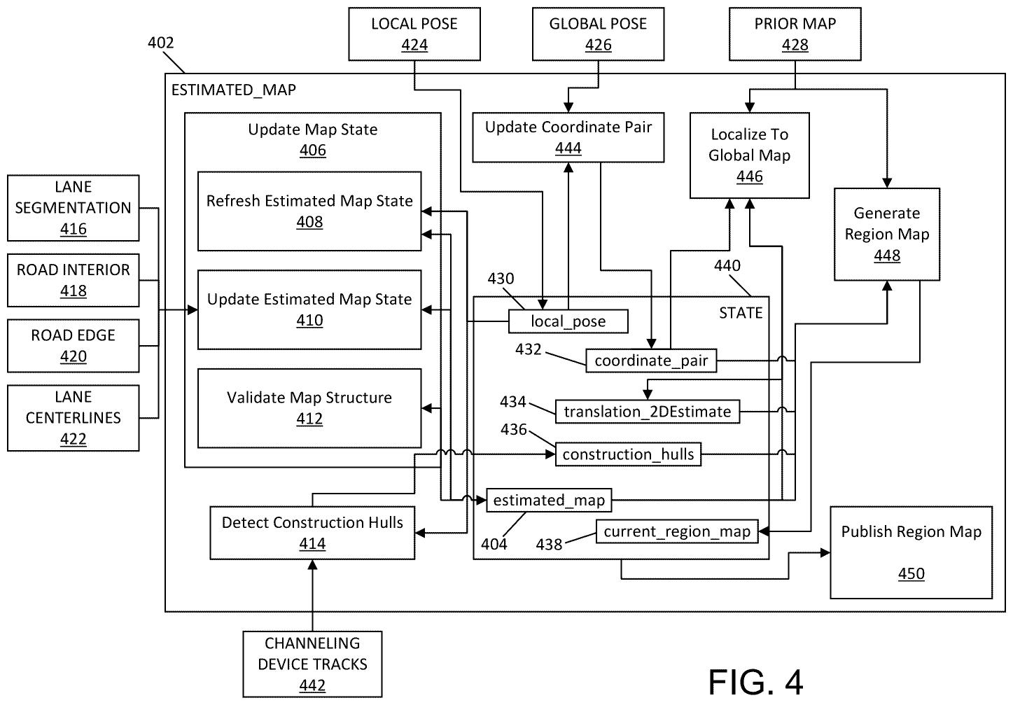

Referring now to FIG. 4, a block diagram of example software for generating a heatmap is provided.

According to various embodiments, the software may be configured to perform one or more functions 402 in order to generate an estimated map 404. This estimated map 404 may be used in the process of suggesting one or more changes to the vehicle. For example, the changes may comprise a change in direction or speed of the vehicle. Accordingly, the vehicle may be configured to implement the suggestion if it is operating in an autonomous mode.

According to various embodiments, the estimated map 404 comprises a map state. The map state may comprise one or more components of the map such as, e.g., a local pose (e.g., local_pose 430), a coordinate pair (e.g., coordinate_pair 432), a translation of a 2-dimensional estimate (e.g., translation_2DEstimate 434), one or more construction hulls (e.g., construction_hulls 436), the estimated map (e.g., estimated_map 404), and a current region map (e.g., current_region_map 438). The map state may be updated 406 with, e.g., measurement frames.

According to various embodiments, measurement frames are measurements of the environment that are incorporated into the map state estimate by way of an update step. An example measurement is the detection of road interior by the front left long-range camera (there are many environmental features detected and many sensors with detectors making such measurement observations). This measurement may be used to update the state of the road surface and lanes in the map state estimate, by way of a data-fitting update step: a state estimate that may approximately best match past measurement observations (“measurement frames”) and the new measurement frame is produced.

This updating may comprise refreshing an estimated map state 408 (e.g., by refocusing the estimated map state, pruning segments, etc.), updating an estimated map state 410 (e.g., extending, updating, initiating, etc. the estimated map state), validating a map structure 412 (e.g., parsing segments, parsing structure, etc.), and/or via one or more other suitable means, while maintaining the spirit and functionality of the present disclosure.

According to various embodiments, construction hulls may be detected 414 (e.g., using convex hull creation), and this detection may influence, or be influenced by, the refreshed estimated map state. According to various embodiments, device tracks may be channeled 442 in the detection of the construction hulls 414.

According to various embodiments, channelizing devices may be construction cones and barrels. They are produced in 3D by a neural network. Convex hulls may be produced by a LiDAR geometric clustering model that groups lidar points together (“obstacle detection”: things that cannot be hit, etc.). These may be both used as measurements to determine where the vehicle should drive.

According to various embodiments, the estimated map state may be updated based on the incorporation of one or more elements such as, e.g., lane segmentation 416, road interior 418, road edge 420, lane centerlines 422, and/or other suitable elements.

According to various embodiments, one or more external data points may be incorporated into the determination of the map state. For example, a local pose 424, a global pose 426, and a prior map 428 may be incorporated into the determination of the map state. These external data points may be incorporated into the generation of the map state 440

According to various embodiments, the local pose 424 may be incorporated (local_pose 430) into the map state 440. The local pose 430 may be used in the refreshing 408 if the estimated heat map. The local pose 430 and the global pose 426 may be used to update 444 the coordinate pair, in order to generate coordinate pair 432. The coordinate pair 432, the prior map 428, and/or the estimated map 404 may be used to localize the information to a global map 446. The coordinate pair 432, the translation of the 2-dimensional estimate 434, the construction hulls 436, the estimated map 404, and the prior map 428 may be used to generate 448 a region map, which may be used to generate the current region map 438.

According to various embodiments, the region map may be published 450. According to various embodiments, the regional map may be used in the determination of one or more actions by a vehicle. The one or more actions may comprise a change in speed of the vehicle, a change of direction of the vehicle, and/or one or more other suitable actions.

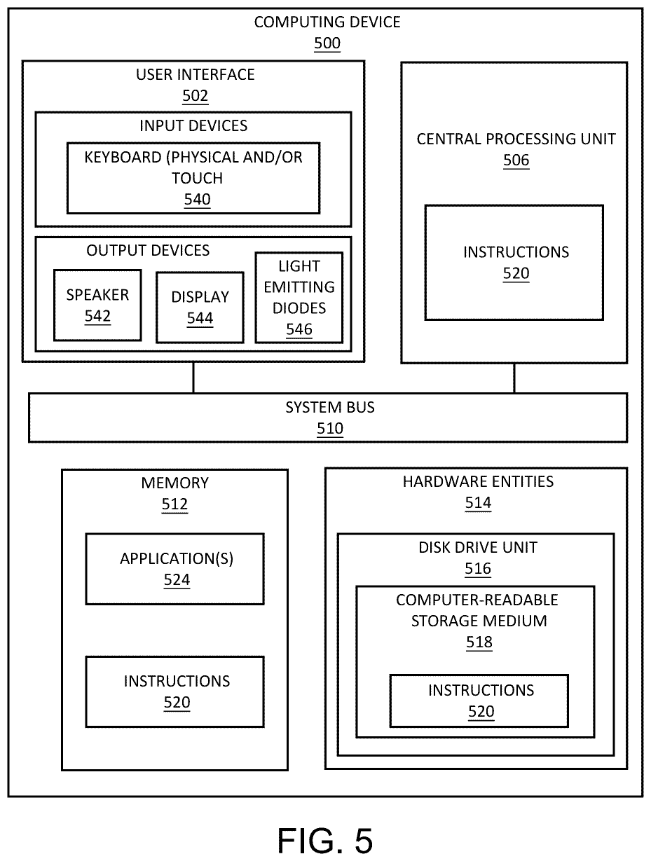

Referring now to FIG. 5, an illustration of an example architecture for a computing device 500 is provided. The computing device 130 of FIG. 1 may be the same as or similar to computing device 500. As such, the discussion of computing device 500 is sufficient for understanding the computing device 130 of FIG. 1, for example.

Computing device 500 may comprise more or less components than those shown in FIG. 1. The hardware architecture of FIG. 5 represents one example implementation of a representative computing device configured to one or more methods and means for identifying a vehicle subject to an emergency alert, as described herein. As such, the computing device 500 of FIG. 5 may be configured to implement at least a portion of the method(s) described herein (for example, method 300 of FIG. 3).

Some or all components of the computing device 500 may be implemented as hardware, software and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to and/or programmed to perform one or more of the methodologies, procedures, or functions described herein.

As shown in FIG. 5, the computing device 500 may comprise a user interface 502, a Central Processing Unit (“CPU”) 506, a system bus 510, a memory 512 connected to and accessible by other portions of computing device 500 through system bus 510, and hardware entities 514 connected to system bus 510. The user interface may comprise input devices and output devices, which facilitate user-software interactions for controlling operations of the computing device 500. The input devices may comprise, but are not limited to, a physical and/or touch keyboard 550. The input devices may be connected to the computing device 500 via a wired or wireless connection (e.g., a Bluetooth® connection). The output devices may comprise, but are not limited to, a speaker 552, a display 554, and/or light emitting diodes 556.

At least some of the hardware entities 514 perform actions involving access to and use of memory 512, which may be a Random Access Memory (RAM), a disk driver and/or a Compact Disc Read Only Memory (CD-ROM), among other suitable memory types. Hardware entities 514 may comprise a disk drive unit 516 comprising a computer-readable storage medium 518 on which is stored one or more sets of instructions 520 (e.g., programming instructions such as, but not limited to, software code) configured to implement one or more of the methodologies, procedures, or functions described herein. The instructions 520 may also reside, completely or at least partially, within the memory 512 and/or within the CPU 506 during execution thereof by the computing device 500. The memory 512 and the CPU 506 also may constitute machine-readable media. The term “machine-readable media”, as used here, may refer to a single medium or multiple media (e.g., a centralized or distributed database, and/or associated caches and servers) that store the one or more sets of instructions 520. The term “machine-readable media”, as used here, also may refer to any medium that is capable of storing, encoding or carrying a set of instructions 520 for execution by the computing device 500 and that cause the computing device 500 to perform any one or more of the methodologies of the present disclosure.

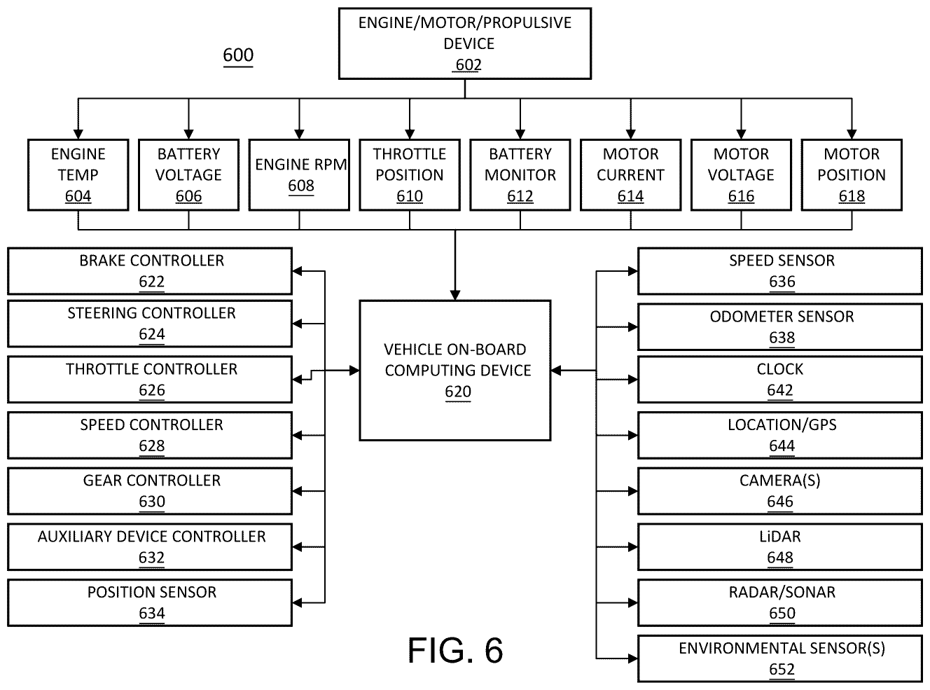

Referring now to FIG. 6, an example vehicle system architecture 600 for a vehicle is provided, in accordance with various embodiments of the present disclosure.

Vehicle 105 of FIG. 1 may have the same or similar system architecture as that shown in FIG. 6. Thus, the following discussion of the vehicle system architecture 600 is sufficient for understanding the vehicle 105 FIG. 1.

As shown in FIG. 6, the vehicle system architecture 600 may comprise an engine, motor or propulsive device (e.g., a thruster) 602 and various sensors 604-618 for measuring various parameters of the vehicle system architecture 600. In gas-powered or hybrid vehicles having a fuel-powered engine, the sensors 604-618 may comprise, for example, an engine temperature sensor 604, a battery voltage sensor 606, an engine Rotations Per Minute (RPM) sensor 608, and/or a throttle position sensor 610. If the vehicle is an electric or hybrid vehicle, then the vehicle may comprise an electric motor, and accordingly will have sensors such as a battery monitoring system 612 (to measure current, voltage and/or temperature of the battery), motor current 614 and voltage 616 sensors, and motor position sensors such as resolvers and encoders 618.

Operational parameter sensors that are common to both types of vehicles may comprise, for example: a position sensor 634 such as an accelerometer, gyroscope and/or inertial measurement unit, a speed sensor 636, and/or an odometer sensor 638. The vehicle system architecture 600 also may comprise a clock 642 that the system uses to determine vehicle time during operation. The clock 642 may be encoded into the vehicle on-board computing device 620, it may be a separate device, or multiple clocks may be available.

The vehicle system architecture 600 also may comprise various sensors that operate to gather information about the environment in which the vehicle is traveling. These sensors may comprise, for example: a location sensor 644 (for example, a Global Positioning System (GPS) device), such as, e.g., location detection system 145 in FIG. 1, object detection sensors such as one or more cameras 646; a LiDAR sensor system 648; and/or a RADAR and/or a sonar system 650. The sensors also may comprise environmental sensors 552 such as a precipitation sensor and/or ambient temperature sensor. The object detection sensors may be configured to enable the vehicle system architecture 600 to detect objects that are within a given distance range of the vehicle 105 in any direction, while the environmental sensors 652 collect data about environmental conditions within the vehicle's area of travel.

During operations, information is communicated from the sensors to an on-board computing device 620. The on-board computing device 620 may be configured to analyze the data captured by the sensors and/or data received from data providers, and may be configured to optionally control operations of the vehicle system architecture 600 based on results of the analysis. For example, the on-board computing device 620 may be configured to control: braking via a brake controller 622; direction via a steering controller 624: speed and acceleration via a throttle controller 626 (in a gas-powered vehicle) or a motor speed controller 628 (such as a current level controller in an electric vehicle); a differential gear controller 630 (in vehicles with transmissions), and/or other controllers.

Geographic location information may be communicated from the location sensor 644 to the on-board computing device 620, which may then access a map of the environment that corresponds to the location information to determine known fixed features of the environment such as streets, buildings, stop signs and/or stop/go signals. Captured images from the cameras 646 and/or object detection information captured from sensors such as Li DAR 648 is communicated from those sensors to the on-board computing device 620. The object detection information and/or captured images are processed by the on-board computing device 620 to detect objects in proximity to the vehicle. Any known or to be known technique for making an object detection based on sensor data and/or captured images may be used in the embodiments disclosed in this document.

The features and functions described above, as well as alternatives, may be combined into many other different systems or applications. Various alternatives, modifications, variations or improvements may be made by those skilled in the art, each of which is also intended to be encompassed by the disclosed embodiments.

1. A method for detecting a portion of an environment of a vehicle, comprising:
generating, using one or more sensors coupled to a vehicle, environment data from an environment of the vehicle, wherein the environmental data comprises one or more of the following:
ground LiDAR data from the environment;
camera data from the environment; and
path data corresponding to a change in position of one or more other vehicles within the environment;
inputting the environmental data into a machine learning model trained to generate a heatmap; and
using a processor:
based on the environmental data, determining a portion of the environment, wherein the portion of the environment comprises an area having a likelihood, greater than a minimum threshold, of being adjacent to one or more pavement markings; and
generating the heatmap,
wherein the heatmap corresponds to the portion of the environment.

2. The method of claim 1, wherein the one or more sensors comprise one or more of the following:
one or more LiDAR systems;
one or more cameras; and
one or more RADAR systems.

3. The method of claim 1, wherein the ground LiDAR data comprises a 2-dimensional grouping of data points within the environment.

4. The method of claim 1, wherein generating ground LiDAR data comprises:
capturing, using one or more LiDAR systems, 3-dimensional LiDAR data from the environment; and
distilling the 3-dimensional LiDAR data to the ground lidar data.

5. The method of claim 1, wherein:
the one or more sensors comprise one or more cameras configured to generate one or more images, and
the camera data comprises one or more images.

6. The method of claim 1, wherein:
the processor is configured to run the machine learning model, and
the machine learning model comprises a neural network.

7. The method of claim 1, wherein generating path data corresponding to a change in position of the one or more other vehicle in the environment comprises:
using the processor:
identifying, using image recognition, a first position of one of the one or more other vehicles at a first time;
identifying, using image recognition, a second position of the one of the one or more other vehicles at a second time,
wherein the second time is after the first time;
determining a change in position between the first position and the second position; and
generating a visual representation of the change in position.

8. A system for generating a heatmap, the system comprising:
a vehicle; and
an imaging module, coupled to the vehicle, the imaging module comprising:
one or more cameras, configured to capture an image depicting an environment within view of the one or more cameras; and
a processor, configured to:
generate, using one or more sensors coupled to a vehicle, environment data from an environment of the vehicle, wherein the environmental data comprises one or more of the following:
ground LiDAR data from the environment;
camera data from the environment; and
path data corresponding to a change in position of one or more other vehicles within the environment;
input the environmental data into a machine learning model trained to generate a heatmap;
based on the environmental data, determine a portion of the environment, wherein the portion of the environment comprises an area having a likelihood, greater than a minimum threshold, of being adjacent to one or more pavement markings; and
generate the heatmap, wherein the heatmap corresponds to the portion of the environment.

9. The system of claim 8, wherein the one or more sensors comprise one or more of the following:
one or more LiDAR systems;
one or more cameras; and
one or more RADAR systems.

10. The system of claim 8, wherein the ground LiDAR data comprises a 2-dimensional grouping of data points within the environment.

11. The system of claim 8, wherein generating ground LiDAR data comprises:
capturing, using one or more LiDAR systems, 3-dimensional LiDAR data from the environment; and
distilling the 3-dimensional LiDAR data to the ground lidar data.

12. The system of claim 8, wherein:
the one or more sensors comprise one or more cameras configured to generate one or more birds-eye-view images, and
the camera data comprises one or more birds-eye-view images.

13. The system of claim 8, wherein:
the processor is configured to run the machine learning model, and
the machine learning model comprises a convolutional neural network.

14. The system of claim 8, wherein generating path data corresponding to a change in position of the one or more other vehicle in the environment comprises:
using the processor:
identifying, using image recognition, a first position of one of the one or more other vehicles at a first time;
identifying, using image recognition, a second position of the one of the one or more other vehicles at a second time,
wherein the second time is after the first time;
determining a change in position between the first position and the second position; and
generating a visual representation of the change in position.

15. A system, comprising:
an imaging device comprising one or more cameras, the imaging device coupled to a vehicle, wherein the one or more cameras are configured to capture an image depicting an environment within view of the one or more cameras; and
a computing device, including a processor and a memory, coupled to the vehicle, configured to store programming instructions that, when executed by the processor, cause the processor to:
generate, using one or more sensors coupled to a vehicle, environment data from an environment of the vehicle, wherein the environmental data comprises one or more of the following:
ground LiDAR data from the environment;
camera data from the environment; and
path data corresponding to a change in position of one or more other vehicles within the environment;
input the environmental data into a machine learning model trained to generate a heatmap;
based on the environmental data, determine a portion of the environment, wherein the portion of the environment comprises an area having a likelihood, greater than a minimum threshold, of being adjacent to one or more pavement markings; and
generate the heatmap,
wherein the heatmap corresponds to the portion of the environment.

16. The system of claim 15, wherein the one or more sensors comprise one or more of the following:
one or more LiDAR systems;
one or more cameras; and
one or more RADAR systems.

17. The system of claim 15, wherein the ground LiDAR data comprises a 2-dimensional grouping of data points within the environment.

18. The system of claim 15, wherein, in the generating ground LiDAR data, the programming instructions, when executed by the processor, are further configured to cause the processor to:
capture, using one or more LiDAR systems, 3-dimensional LiDAR data from the environment; and
distill the 3-dimensional LiDAR data to the ground lidar data.

19. The system of claim 15, wherein:
the processor is configured to run the machine learning model, and
the machine learning model comprises a convolutional neural network.

20. The system of claim 15, wherein, in the generating path data corresponding to a change in position of the one or more other vehicle in the environment, the programming instructions, when executed by the processor, are further configured to cause the processor to:
identify, using image recognition, a first position of one of the one or more other vehicles at a first time;
identify, using image recognition, a second position of the one of the one or more other vehicles at a second time,
wherein the second time is after the first time;
determine a change in position between the first position and the second position; and
generating a visual representation of the change in position; and
generate a visual representation of the change in position.
